(19) United States
(12) Patent Application Publication
(10) Pub. No.: US 2025/0293270 A1
(43) Pub. Date: Sep. 18, 2025

(54) METHOD OF SHAPING BIPOLAR PLATES

(71) Applicant: GM Global Technology Operations LLC, Detroit, MI (US)

(72) Inventor: Siguang Xu, Rochester Hills, MI (US)

(73) Assignee: GM Global Technology Operations LLC, Detroit, MI (US)

(21) Appl. No.: 18/605,230

(22) Filed: Mar. 14, 2024

(51) Int. Cl. H01M 8/0206; B21D 22/20; H01M 8/0258

(52) U.S. Cl. CPC H01M 8/0206; B21D 22/20; H01M 8/0258; H01M 2250/20

(57) ABSTRACT

A method of preparing a bipolar plate for a fuel cell includes placing a sheet in a bipolar plate forming apparatus, deforming a first region the sheet in a first stage between a first die and a first punch, the first stage forming one or more walls and one or more apexes, deforming a second region of the sheet in a second stage between a second die and a second punch, the second region being arranged laterally on either side of the of the first region, the second stage forming at least one first flat and at least one second flat on either side of the one or more walls, and deforming a third region of the sheet in a third stage between a third die and a third punch, the third region being arranged laterally between the first region and the second region.

### GOVERNMENT FUNDING

This invention was made with Government support under Agreement No. DE-EE0009616 HD Bipolar Plate awarded by the Department of Energy. The Government may have certain rights in the invention.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a method of forming bipolar plates and, more particularly, a method of forming bipolar plates using less formable materials.

Typically, bipolar plates for fuel cell systems are made from a metal or other electrically conductive material in order to form an electrical pathway between a membrane electrode assembly and an external electric circuit. The bipolar plates operate at high temperatures and in a corrosive environment so conventional metals such as plain carbon steel may not be suitable for some applications. Alloyed metals, such as stainless steel, may be used to form the bipolar plates as they have desirable corrosion-resistant properties. For example, stainless steels with ferritic microstructures (i.e., ferritic stainless steel) typically have good corrosion resistance due to a high chromium content.

Ferritic stainless steel as well as other desirable materials are commonly susceptible to necking, thinning, and cracking when exposed to conventional stamping or related metal forming operations (e.g., hydroforming). These shortcomings are prevalent in single-step operations or in operations where rapid wall deformation may take place. The shortcomings of existing systems and methods will be addressed by one or more aspects of the present disclosure.

### SUMMARY

In one configuration, a method of preparing a bipolar plate for a fuel cell is provided and includes placing a sheet in a bipolar plate forming apparatus, deforming a first region of the sheet in a first stage between a first die and a first punch, the first stage forming one or more walls and one or more apexes, deforming a second region of the sheet in a second stage between a second die and a second punch, the second region being arranged laterally on either side of the of the first region, the second stage forming at least one first flat and at least one second flat on either side of the one or more walls, and deforming a third region of the sheet in a third stage between a third die and a third punch, the third region being arranged laterally between the first region and the second region, the third stage forming the sheet so that a final draw depth between the at least one first flat and the at least one second flat is increased.

The method may include one or more of the following optional features. For example, the sheet may include one of ferritic stainless steel, austenitic stainless steel, titanium, or aluminum.

According to at least one aspect, the sheet may include a pitch between 0.7 millimeters and 1.6 millimeters.

According to another aspect, the sheet may include a land width between 0.1 millimeters and 0.5 millimeters.

According to at least one example, the sheet may include a channel span between 0.2 millimeters and 1.1 millimeters.

According to another example, the final draw depth may be between 0.26 and 0.6 millimeters.

According to at least one aspect, the sheet may include a sheet thickness between about 50 microns and 200 microns. The sheet comprises a maximum thinning of about 20-24% of the sheet thickness and a flat length of about 294-300 microns.

According to another aspect, the sheet may include a maximum thinning of less than 24% of the sheet thickness. The sheet may include a flat length of greater than 226 microns.

In another configuration, a method of preparing a bipolar plate for a fuel cell is provided and includes placing a substantially planar metal sheet comprising a thickness into engagement with a tool and shaping the metal sheet using three-step forming to form the metal sheet into a substantially non-planar shape that includes a surface profile comprising one or more walls, one or more lands, one or more intersections, and one or more channel floors. The three-step forming including a first shaping step wherein the tool forms a first region of the substantially planar metal sheet, the first shaping step forming a first draw depth. The three-step forming further including a second shaping step wherein the tool forms a second region of the substantially planar metal sheet that is arranged laterally on either side of the first region, the second step forming a second draw depth. The three-step forming further including a third shaping step wherein the tool forms a third region of the substantially planar metal sheet that is arranged laterally between the first region and the second region, the third shaping step forming a final draw depth.

The method may include one or more of the following optional features. For example, the sheet may include one of ferritic stainless steel, austenitic stainless steel, titanium, or aluminum.

According to at least one aspect, the sheet comprises a sheet thickness between about 50 microns and 200 microns. The sheet comprises a maximum thinning of about 20-24% of the sheet thickness and a flat length of about 294-300 microns.

According to another aspect, the sheet may include a maximum thinning of less than 24% of the sheet thickness. The sheet may include a flat length of greater than 226 microns.

In yet another configuration, a fuel cell for a vehicle is provided and includes a proton exchange member, an anode catalyst layer in contact with one face of the proton exchange member, a cathode catalyst layer in contact with another face of the proton exchange member, an anode diffusion layer in contact with the anode catalyst layer, a cathode diffusion layer in contact with the cathode catalyst layer, a first bipolar plate engaged with the anode diffusion layer, and a second bipolar plate engaged with the cathode diffusion layer. The first bipolar plate and the second bipolar plate each including a pre-formed thickness, one or more first flats comprising a first flat length greater than 226 microns, one or more second flats comprising a second flat length greater than 226 microns, and one or more intersections between the first flats and the second flats comprising thinning of less than 24% of a pre-formed plate thickness.

The fuel cell may include one or more of the following optional features. For example, the first flat length of the one or more first flats may be between 294-300 microns.

According to one example, the second flat length of the one or more second flats may be between 294-300 microns. The first bipolar plate and the second bipolar plate each can include a pre-formed thickness between about 50 microns and 200 microns. The one or more intersections can include thinning between 20-24% of the pre-formed plate thickness.

### BRIEF DESCRIPTION OF THE DRAWINGS

The drawings described herein are for illustrative purposes only of selected configurations and are not intended to limit the scope of the present disclosure.

FIG. 1 is a perspective view of a fuel cell stack including one or more fuel cells according to principles of the present disclosure;

FIG. 2 is a partial exploded sectional view of a portion of one of the fuel cells of FIG. 1;

FIG. 3 is a cross-sectional view of a sheet that was subjected to a one-step forming process according to the prior art;

FIGS. 4A and 4B are cross-sectional views of a sheet that was subjected to a two-step forming process according to the prior art;

FIGS. 5A, 5B, and 5C are cross-sectional views of a sheet subjected to a three-step forming process according to the principles of the present disclosure;

FIG. 6 shows results of a one-step forming process, a two-step forming process, and a three-step forming process according to principles of the present disclosure;

FIG. 7 is a cross-sectional view of a portion of one of the fuel cells of FIG. 1; and

FIG. 8 shows various steps used in a progressive formation of a bipolar plate according to principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

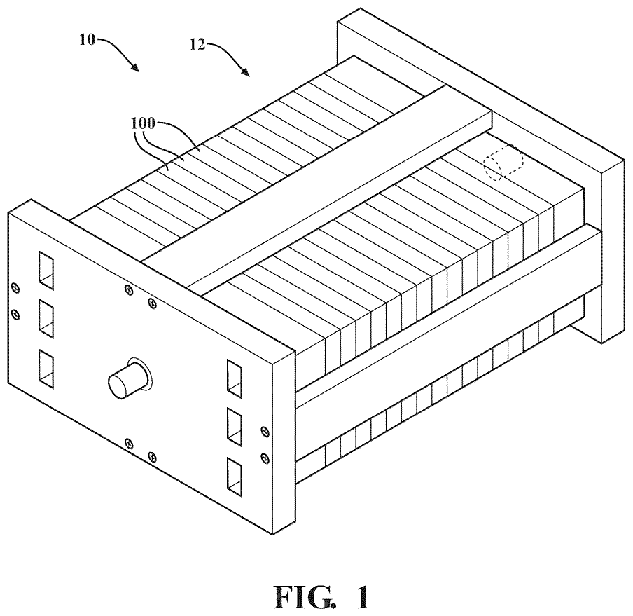

Referring to FIG. 1, a fuel cell stack 10 comprises a stacked body 12 that includes one or more power generation units or fuel cells 100 stacked with respect to one another. The fuel cell stack 10 may be mounted in a vehicle (not shown), such as a fuel cell vehicle or fuel cell electric automobile, a stationary power generation station, and/or a mobile charging station.

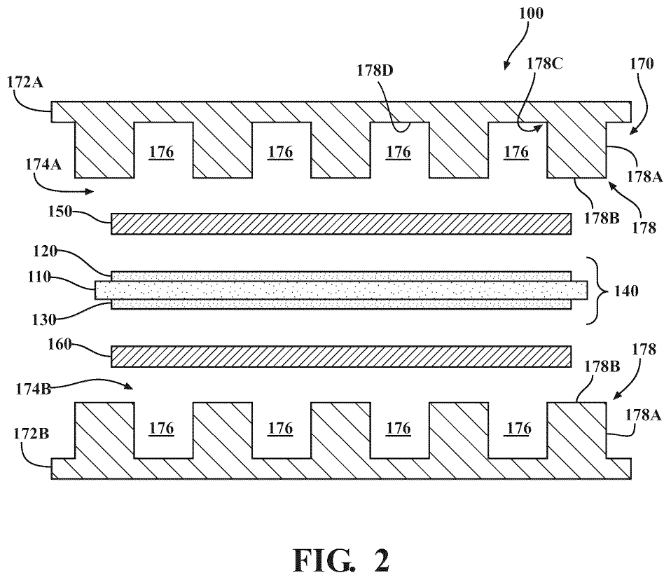

With reference to FIG. 2, the one or more fuel cells 100 include a proton exchange membrane 110, an anode catalyst layer 120 in contact with one face of the proton exchange membrane 110, and a cathode catalyst layer 130 in contact with another face of the proton exchange membrane 110. The proton exchange membrane 110 and catalyst layers 120, 130 can be referred to as a membrane electrode assembly (MEA) 140. An anode diffusion layer 150 is arranged in contact with the anode catalyst layer 120, while a cathode diffusion layer 160 is arranged in contact with the cathode catalyst layer 130. The diffusion layers 150, 160 can be made with a porous construction to facilitate the passage of gaseous reactants to the catalyst layers 120, 130. The anode catalyst layer 120 and the cathode catalyst layer 130 are referred to as electrodes, and can be formed as separate distinct layers as shown or, alternatively, as embedded at least partially in diffusion layers 150, 160 respectively, as well as embedded partially in opposite faces of the proton exchange membrane 110.

In addition to providing a substantially porous flow path for reactant gases to reach the appropriate side of the proton exchange membrane 110, the diffusion layers 150, 160 provide electrical contact between the electrode catalyst layers 120, 130 and a bipolar plate 170 that in turn act as a current collector. Moreover, by its porous nature, the diffusion layers 150, 160 also form a conduit for removal of product gases generated at the catalyst layers 120, 130. Furthermore, the cathode diffusion layer 160 generates significant quantities of water vapor in the cathode diffusion layer. This may be desirable for helping to keep the proton exchange membrane 110 hydrated. Water permeation in the diffusion layers 150, 160 can be adjusted through the introduction of small quantities of polytetrafluoroethylene (PTFE) or related material, for example.

With continued reference to FIG. 2, the bipolar plate 170 includes a first plate 172A and a second plate 172B. The first plate 172A and the second plate 172B each can be defined by a pre-formed thickness (e.g., 50 microns and 200 microns) (not shown). The first and second plates 172A, 172B include opposing surfaces 174A, 174B that separate each MEA 140 and accompanying diffusion layers 150, 160 from adjacent MEAs and layers of the stacked body 12. The first plate 172A engages the anode diffusion layer 150 while the second plate 172B engages the cathode diffusion layer 160. Each plate 172A, 172B (which upon assembly as a unitary whole would make up the bipolar plate 170) defines numerous reactant gas flow channels 176. The channels 176 may be defined by three-dimensional (i.e., out-of-plane) structure 178 made up of wall(s) 178A, land(s) or first flats 178B, and intersection(s) (i.e., bends or radii) 178C that separate adjacent sections of the reactant gas flow channels 176 by projecting toward and making direct contact with the respective diffusion layers 150, 160. The channels 176 may be further defined by a channel floor or second flat 178D or a portion of the plates 172A, 172B arranged laterally between each structure 178. Although the plates 172A, 172B are shown defining purely rectangular reactant gas flow channels 176 and structure 178, the configuration of and shape of the gas flow channels 176 and the structure 178 may be further defined and will be discussed in more detail below.

In operation, a first gaseous reactant, such as hydrogen, is delivered to the anode 120 side of the MEA 140 through the channels 176 from plate 172A, while a second gaseous reactant, such as oxygen (e.g., air) is delivered to the cathode 130 side of the MEA 140 through the channels 176 from plate 172B. Catalytic reactions occur at the anode 120 and the cathode 130 respectively, producing protons that migrate through the proton exchange membrane 110 and electrons that result in an electric current that may be transmitted through the diffusion layers 150, 160 and bipolar plate 170 by virtue of contact between the lands 178B and the layers 150, 160.

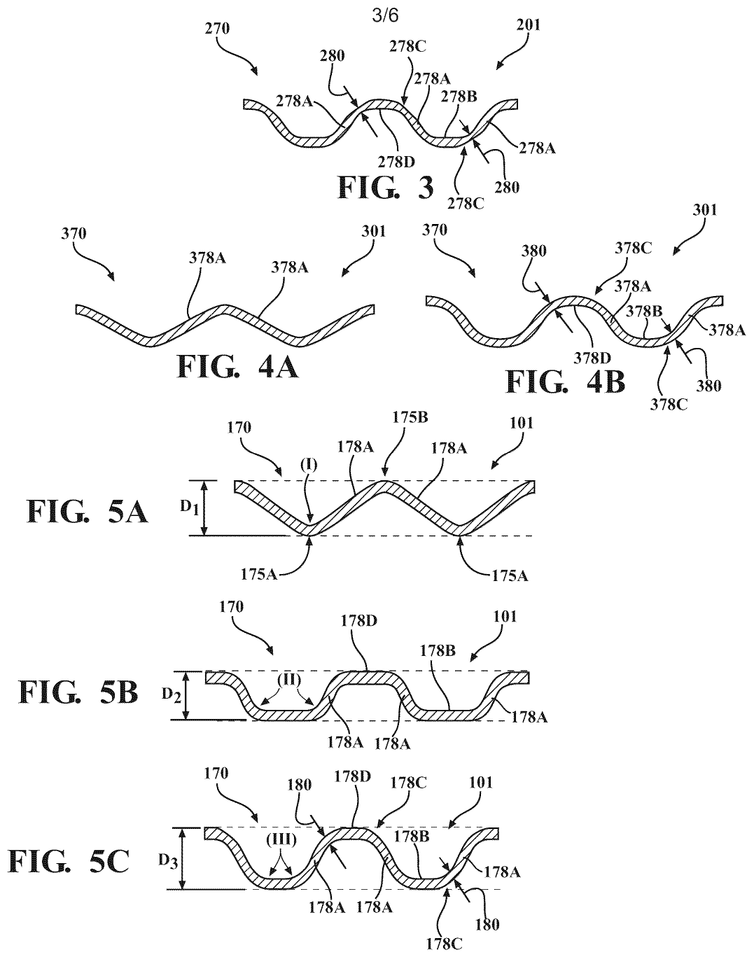

Referring to FIGS. 3, 4A-4B, and 5A-5C, results of one-step, two-step, and three step forming of ferritic stainless steel sheets (i.e., blanks) 101, 201, 301 into bipolar plates 170, 270, 370 are provided. Sheets 201 and 301 are formed using one-step and two-step forming, respectively, and according to the prior art. Sheet 101 is formed using three-step forming in accordance with the principles of the present disclosure. The sheets 101, 201, 301 may be made of another material such as austenitic stainless steel, titanium, an alloy, or a material commonly used to form bipolar plates. The sheets 101, 201, 301 may be between 50 microns and about 200 microns in thickness.

Upon forming the sheets 101, 201, 301, a generally continuous surface profile made up of side walls 178A, 278A, 378A, lands 178B, 278B, 378B, intersections 178C, 278C, 378C, and channel floors 178D, 278D, and 378D are provided. Each sheet 101, 201, 301 includes unique surface profiles according to each of the forming processes (i.e., one-step, two-step, or three-step forming). More specifically, the sheets 101, 201, 301 can experience a different degree of thinning along the surface profile depending on which forming process is used. For instance, with reference to FIG. 3, significant thinning 280 (i.e., about 46%) occurs at the intersections 278C between the walls 278A and the channel floor 278D of the sheet 201 and/or between the walls 278A and the land 278B of the sheet 201. With reference to FIG. 4B, significant thinning 380 (i.e., about 33.5%) occurs at the intersections 378C between the walls 378A and the channel floor 378D and/or between the walls 378A and the land 378B of the sheet 301. According to at least one aspect of the present disclosure, three-step forming the sheet 101 only results in about 29% thinning at intersections 178C between the walls 178A and the channel floor 178D and/or between the walls 178A and the land 178B of sheet 101. In other words, gradually forming the sheet using three-step forming may be desirable to utilize less formable (i.e., inexpensive) materials while generally maintaining uniform thickness along the surface profile of the sheet 101.

With reference again to FIG. 3, one-step forming of sheet 201 results in the land 278B being generally curved. Likewise, with reference to FIG. 4B, two-step forming of sheet 301 results in land 378B being generally curved. In contrast, three-step forming of sheet 101 results in the land 178B being generally flat (i.e., planar) rather than curved. It may be desirable to have a flatter (i.e., more planar) land 178B to improve performance (e.g., reduce contact resistance and voltage drop) between the bipolar plate 172A, 172B and the diffusion layers 150, 160, for example. According to one aspect of the present disclosure, the land or first flat 178B is generally parallel to the channel floor or second flat 178D.

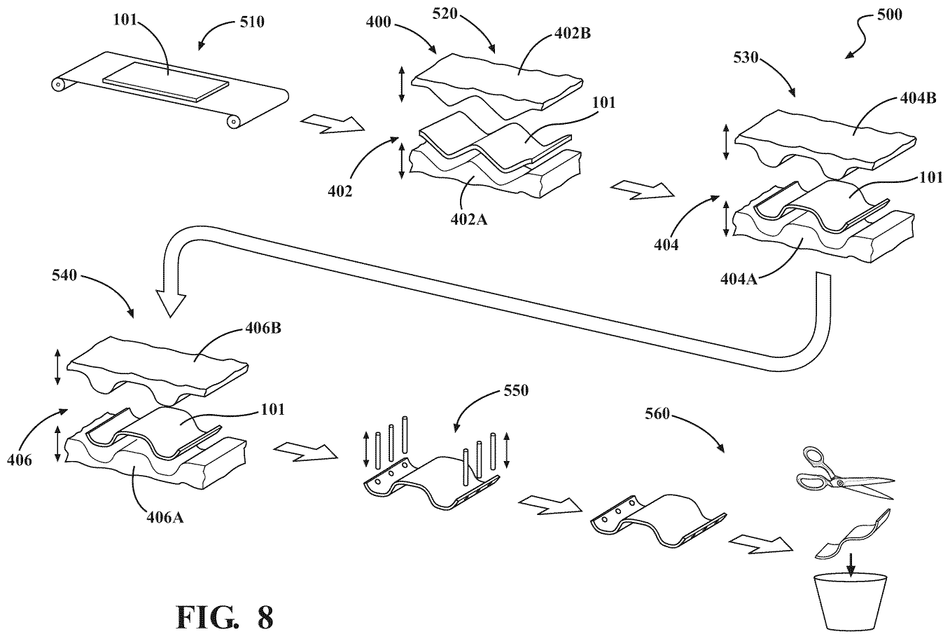

With reference to FIG. 8, a bipolar plate forming apparatus 400 is provided for forming the sheet 101 into the bipolar plate 170. The bipolar plate forming apparatus 400 can include a first stage 402 that includes a first die 402A and a first punch 402B, a second stage 404 that includes a second die 404A and a second punch 404B, and a third stage 406 that includes a third die 406A and a third punch 406B. The first stage 402 may be configured for a first or deep draw depth D₁, as shown in FIG. 5A. For instance, the first draw depth Di may be 50-100% of a third or final draw depth D₃ (FIG. 5C). The second stage 406 may be configured for a second or shallow draw depth D₂, as shown in FIG. 5B. In other words, the second draw depth D₂ may be 30-90% of the final draw depth D₃ (FIG. 5C).

In general, three-step forming or using the first stage 402, the second stage 404, and third stage 406 to form the sheet 101 may be desirable to target and gradually deform specific areas of the sheet 101 at each stage of the forming process. Gradual formation of the sheet 101 may also be desirable for providing a generally uniform thickness upon deformation. Deforming the sheet 101 in the first stage 402 between the first die 402A and the first punch 402B can form a first region (I) of the sheet. In other words, as shown in FIG. 5A, the first die 402A and the first punch 402B can form one or more apexes, such as a first apex 175A and a second apex 175B, between the one or more walls 178A. Deforming the sheet 101 in the second stage 404 between the second die 404A and the second punch 404B can form a second region (II) of the sheet. The second region (II) may be arranged laterally on either side of the first region. In the present example, as shown in FIG. 5B, the second die 404A and the second punch 404B form a portion of the walls 178A to define the land or first flat 178B and the channel floor or second flat 178D. Deforming the sheet 101 in the third stage 406 between the third die 406A and the third punch 406B can form a third region (III) of the sheet 101 that is arranged laterally between the first region (I) and the second region (II). Stated differently, in the third stage 406, the final draw depth D₃ between the first flat 178B and the second flat 178D may be increased while a width of the second flat 178D and/or 178B is decreased. Additionally or alternatively, the land or first flat 178B may be formed so as to be substantially parallel to the channel floor or second flat 178D, as shown in FIG. 5C.

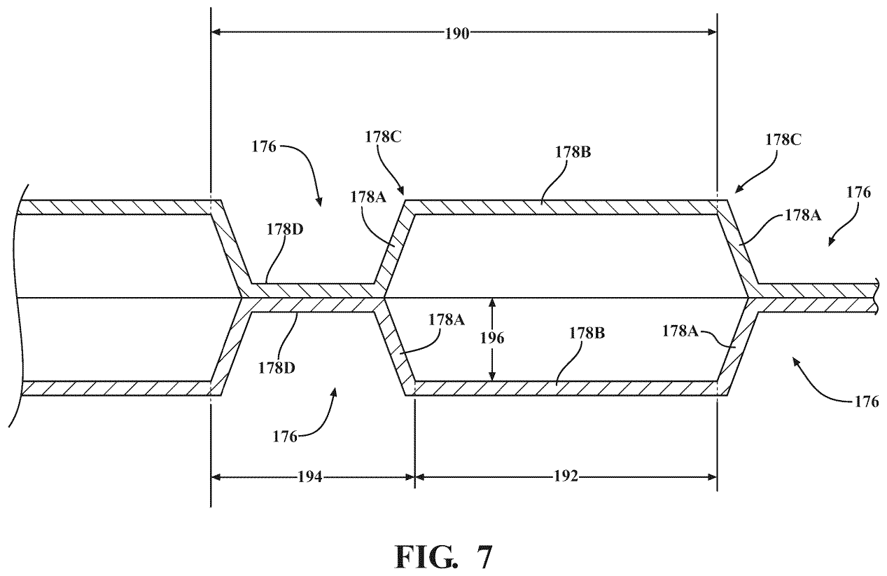

With reference to FIG. 7, three-step forming improves dimensional accuracy of the bipolar plate 170 which can improve performance of the bipolar plate 170. A pitch 190 may be determined by adding a land width 192 of the lands 178B with a channel span 194 of the channels 176. The pitch 190 can be between 0.7 and 1.6 millimeters (mm) when the sheet 101 is formed with the three-step forming process. The land width 192 can be between 0.1 mm and 0.5 mm and the channel span 194 can be between 0.2 mm and 1.1 mm. The depth 196 (i.e., distance between the land or first flat 178B and the channel floor or second flat 178D) can be between 0.26 and 0.6 mm.

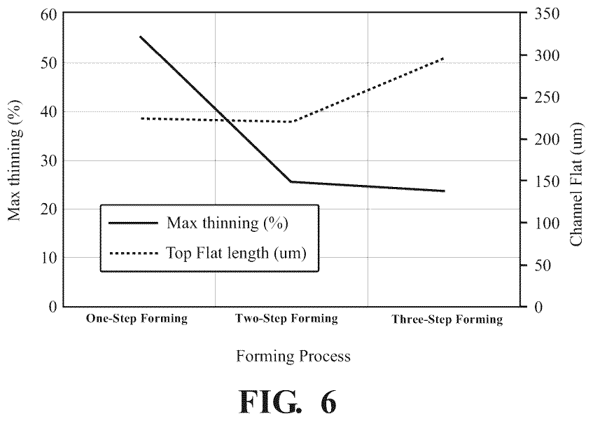

With reference to FIG. 6, results of forming a sheet using a one-step forming process, a two-step forming process, and a three-step forming process according to the principles of the present disclosure are provided. In general, the three-step forming process can reduce thickness reduction (i.e., thinning) while increasing a flat length of the sheet. The three-step forming process of the sheet results in a maximum thinning of about 20-24% of the thickness of the sheet and a flat length of about 294-300 microns. In comparison, a one-step forming process of the sheet results in a maximum thinning of about 54-56% and a flat length of about 220-226 microns (e.g., 224 microns). Also, the two-step forming process of the sheet results in a maximum thinning of 23-27% and a flat length of about 218-222 microns (e.g., 220 microns). Accordingly, the three-step forming of the sheet can include thinning of less than 24% of the sheet thickness and a flat length of greater than 226 microns.

With reference to FIG. 8 in conjunction with FIGS. 1, 2, 5, and 6, a method 500 for forming a bipolar plate via three-step forming is provided. At 510, a substantially planar sheet or blank, such as the sheet 101, is prepared for forming. At 520, 530, 540, a series of shaping steps are performed using the bipolar plate forming apparatus 400.

In a first shaping step 520, the sheet 101 is positioned within the first stage 402 between the die 402A and the punch 402B and is formed in the first region (I). The first shaping step may be configured so that the sheet 101 includes the one or more walls 178A (FIG. 5A) and the first apex 175A and the second apex 175B between the one or more walls 178A.

In a second shaping step 530, the sheet 101 is positioned within the second stage 404 between the die 404A and the punch 404B and is formed in the second region (II). The second shaping step 530 may be configured to include the land or first flat 178B and the channel floor or second flat 178D, as shown in FIG. 5B.

In a third shaping step 540, the sheet 101 is positioned within the third stage 406 between the die 406A and the punch 406B and is formed in the third region (III). The third shaping step may be configured so that the final draw depth D₃ between the first flat 178B and the second flat 178D may be increased while the width of the first flat 178B and the second flat 178D is decreased. Additionally or alternatively, the third shaping step 540 may be configured so that the land or first flat 178B may be formed so as to be substantially parallel to the channel floor or second flat 178D.

From these three shaping steps, step 550 may be used to form additional bipolar plate features, such as piercing of internal features, port openings or the like. Such pierced features may include header openings to distribute fluids to a finished stack assembly (not shown), while port (i.e., anode and cathode) openings provide pathways for reactant fluids to enter or exit each cell. Other features, such as openings to create or support the datum structure for assembly and other knockouts to facilitate assembly and integration (for example, to facilitate cell voltage monitoring) may also be formed. After that, an additional step 560 may be used to provide cutting, trimming, perimeter piercing or related separation of excess material to be discarded. For example, the last station that corresponds to step 560 may be used to punch away the perimeter material to cut the finished bipolar plate 170 out of the strip for collection to a downstream assembly.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method of preparing a bipolar plate for a fuel cell, comprising:
placing a sheet in a bipolar plate forming apparatus;
deforming a first region of the sheet in a first stage between a first die and a first punch, the first stage forming one or more walls and one or more apexes;
deforming a second region of the sheet in a second stage between a second die and a second punch, the second region being arranged laterally on either side of the of the first region, the second stage forming at least one first flat and at least one second flat on either side of the one or more walls; and
deforming a third region of the sheet in a third stage between a third die and a third punch, the third region being arranged laterally between the first region and the second region, the third stage forming the sheet so that a final draw depth between the at least one first flat and the at least one second flat is increased.

2. The method of claim 1, wherein the sheet comprises one of ferritic stainless steel, austenitic stainless steel, titanium, or aluminum.

3. The method of claim 1, wherein the sheet comprises a pitch between 0.7 millimeters and 1.6 millimeters.

4. The method of claim 3, wherein the sheet comprises a land width between 0.1 millimeters and 0.5 millimeters.

5. The method of claim 4, wherein the sheet comprises a channel span between 0.2 millimeters and 1.1 millimeters.

6. The method of claim 1, wherein the final draw depth is between 0.26 and 0.6 millimeters.

7. The method of claim 1, wherein the sheet comprises a sheet thickness between about 50 microns and 200 microns.

8. The method of claim 7, wherein the sheet comprises a maximum thinning of about 20-24% of the sheet thickness and a flat length of about 294-300 microns.

9. The method of claim 7, wherein the sheet comprises a maximum thinning of less than 24% of the sheet thickness.

10. The method of claim 9, wherein the sheet comprises a flat length of greater than 226 microns.

11. A method of preparing a bipolar plate for a fuel cell, comprising:
placing a substantially planar metal sheet comprising a thickness into engagement with a tool; and
shaping the substantially planar metal sheet using three-step forming to form the metal sheet into a substantially non-planar shape that includes a surface profile comprising one or more walls, one or more lands, one or more intersections, and one or more channel floors, the three-step forming comprising:
a first shaping step wherein the tool forms a first region of the substantially planar metal sheet, the first shaping step forming a first draw depth,
a second shaping step wherein the tool forms a second region of the substantially planar metal sheet that is arranged laterally on either side of the first region, the second shaping step forming a second draw depth, and
a third shaping step wherein the tool forms a third region of the substantially planar metal sheet that is arranged laterally between the first region and the second region, the third shaping step forming a final draw depth.

12. The method of claim 11, wherein the sheet comprises a sheet thickness between about 50 microns and 200 microns.

13. The method of claim 12, wherein the sheet comprises a maximum thinning of about 20-24% of the sheet thickness and a flat length of about 294-300 microns.

14. The method of claim 12, wherein the sheet comprises a maximum thinning of less than 24% of the sheet thickness.

15. The method of claim 14, wherein the sheet comprises a flat length of greater than 226 microns.

16. A fuel cell for a vehicle, comprising:
a proton exchange member;
an anode catalyst layer in contact with one face of the proton exchange member;
a cathode catalyst layer in contact with another face of the proton exchange member;
an anode diffusion layer in contact with the anode catalyst layer;
a cathode diffusion layer in contact with the cathode catalyst layer;
a first bipolar plate engaged with the anode diffusion layer; and
a second bipolar plate engaged with the cathode diffusion layer;
wherein the first bipolar plate and the second bipolar plate each comprise:
a pre-formed thickness,
one or more first flats comprising a first flat length greater than 226 microns,
one or more second flats comprising a second flat length greater than 226 microns, and
one or more intersections between the first flats and the second flats comprising thinning of less than 24% of a pre-formed plate thickness.

17. The fuel cell of claim 16, wherein the first flat length of the one or more first flats is between 294-300 microns.

18. The fuel cell of claim 17, wherein the second flat length of the one or more second flats is between 294-300 microns.

19. The fuel cell of claim 18, wherein the first bipolar plate and the second bipolar plate each comprise a pre-formed thickness between about 50 microns and 200 microns.

20. The fuel cell of claim 19, wherein the one or more intersections comprises thinning between 20-24% of the pre-formed plate thickness.
